(19) United States
(12) Patent Application Publication
(10) Pub. No.: US 2026/0022782 A1
(43) Pub. Date: Jan. 22, 2026

(54) PROCESS VALVE, CLAMPING ELEMENT FOR A PROCESS VALVE, METHOD FOR PRODUCING CLAMPING ELEMENTS

(71) Applicant: GEMÜ Gebr. Müller Apparatebau GmbH & Co. Kommanditgesellschaft, Ingelfingen (DE)

(72) Inventors: Simon Matter, Ravenstein (DE); Christian Falkenberger, Bad Mergentheim (DE)

(21) Appl. No.: 19/272,347

(22) Filed: Jul. 17, 2025

(30) Foreign Application Priority Data
Jul. 17, 2024 (DE) 10 2024 120 209.2

(51) Int. Cl. F16K 31/44; F16K 1/36; F16K 27/02

(52) U.S. Cl. CPC F16K 31/44; F16K 1/36; F16K 27/02

(57) ABSTRACT

A process valve includes a valve body with a through-line, a shut-off body having a fastening portion and a shut-off portion movable along an actuation axis to selectively close the through-line, a clamping element, and a drive rod connected to the shut-off portion and extending through an interior of the clamping element. The clamping element includes a clamping portion that tensions the fastening portion in a fluid-tight manner against the valve body, a support portion configured to provide at least indirect support on the valve body, and a spring portion that generates a preloading force to maintain the fastening portion in position. The spring portion includes a curved wall that projects at least partially into the interior of the clamping element and is arranged between the support portion and the clamping portion. The integrated spring portion reduces part count and compensates for settling of the shut-off body during operation.

### TECHNICAL FIELD

This disclosure relates to a process valve, a clamping element for a process valve, and a method for producing clamping elements.

### BACKGROUND

Valves use shut-off bodies, which settle over time. Process valves are commonly used to control the flow of process fluids by means of shut-off bodies that move between open and closed positions. In many conventional designs, the shut-off body is clamped in place using a separate clamping element in combination with one or more disk springs or other preloading structures. Over time, mechanical settling of the shut-off body and wear of the preloading components can lead to reduced sealing performance. Additionally, these multi-part arrangements often require complex assembly steps, involve increased part counts, and may present higher risk of assembly errors or misalignment, particularly in compact valve installations.

### SUMMARY

A first aspect of the description relates to a process valve comprising a valve body having at least one through-line, a shut-off body arranged in the valve body during operation having a fastening portion and having a shut-off portion, wherein the through-line can be closed by means of the shut-off portion movable along an actuation axis, a clamping element arranged in the valve body during operation and a drive rod connected to the shut-off portion and extending through an interior of the clamping element. The clamping element comprises a clamping portion, wherein the fastening portion is tensioned in a fluid-tight manner between the clamping portion and the valve body, a support portion, wherein the clamping element is supported at least indirectly on the valve body by means of the support portion, and a spring portion for forming a preloading force which counteracts a force acting on the support portion of the clamping element through the fastening portion of the shut-off body. The spring portion comprises a curved wall in a section coinciding with the actuation axis. The wall projects at least partially into the interior of the clamping element and is arranged between the support portion and the clamping portion.

By clamping the fastening portion between the valve body and the clamping element, tightness of the fastening portion is ensured. The spring portion ensures that tightness is maintained even after the shut-off body has been reset. Due to the spring portion being integrated as a preloading element into the clamping element, fewer individual parts are required for the process valve. The process valve can therefore be assembled more easily, inexpensively and quickly. Also, the potential for errors during assembly is reduced, because fewer parts are assembled. The quality and reliability of the process valve is thus improved. The curved wall allows for the fastening portion to be tensioned in a material-saving manner. The arrangement of the wall protruding into the interior predetermines an elastic movement of the spring portion inside, so that the process valve is designed to be particularly space-saving. Due to the spring portion being designed as a wall, the spring properties can be adjusted or predetermined easily, precisely and in a way that is appropriate for the application.

In contrast to the prior art, in which the clamping element and the disk springs are designed as multi-part preloading structure, the clamping element and the spring portion are configured as a one-part preloading structure. The spring portion forms a strut-shaped region of the clamping element.

The process valve can also be designed as a valve block, in particular a multi-way valve block, having a plurality of through-lines, wherein, in particular, a through-line connects at least two inlets with at least one outlet and/or at least one inlet with at least two outlets.

In aspects of the present disclosure, the wall has a curved inner side adjoining the interior of the clamping element and a curved outer side adjoining a recess of the clamping element.

In aspects of the present disclosure, the clamping element has a pressure portion comprising the clamping portion, wherein, during operation, the pressure portion, in particular the clamping portion, is arranged between the spring portion and the fastening portion of the shut-off body. The spring portion is hence spaced apart from the fastening portion of the shut-off body along the actuation axis. The clamping element can be rotationally symmetrical and/or hollow and/or arranged coaxially to the actuation axis. The clamping element can be designed to be sleeve-shaped.

In aspects of the present disclosure, the spring portion, in particular the wall, has a first wall thickness and for the clamping portion to have a second wall thickness, wherein the first wall thickness is smaller than the second wall thickness. The spring portion is hence thin-walled and the clamping portion is thick-walled. This results in optimal conditions for force transmission in the region of the shut-off body. The spring element can be thinner than the clamping portion in order to achieve a suitable spring characteristic.

In aspects of the present disclosure, the spring portion has a first portion facing the shut-off body and/or tapering along the actuation axis. The spring portion has a second portion facing away from the shut-off body and/or widening along the actuation axis. Moreover, the spring portion has a curved portion connecting the first portion and the second portion. The curved portion is arranged along the actuation axis between the first portion and the second portion. The curved portion extends in a curved shape or the inner side and/or the outer side of the spring portion extend in a curved shape in the curved portion. The first portion extends along a conical first plane. The second portion extends along a conical second plane. The first portion follows directly after the pressure portion. The outer side of the clamping element extends parallel to the second plane in the transition from the pressure portion to the second portion.

The first wall thickness of the spring portion can be uniform in the first portion and/or in the curved portion and/or in the second portion. The clamping element is thus particularly easy to produce.

In aspects of the present disclosure, the curved portion is concave radially outward with respect to the actuation axis. During operation, a deformation of the spring portion is thus predetermined, wherein the first portion and the second portion are moved toward one another when the clamping element is pretensioned.

In aspects of the present disclosure, the first portion and/or second portion are arranged parallel or obliquely to the actuation axis in the unassembled state and/or during operation. In aspects of the present disclosure, the first portion and/or the second portion form an angle with the actuation axis in a range between and inclusive of, 150° and 175°; and in some aspects, between and inclusive of 160° and 170°. It should be noted that for the first portion and the second portion the smaller angle is measured toward the actuation axis. Due to the clastic design of the spring portion, the angles between the first portion or second portion and the actuation axis change depending on the preloading force and/or valve position. At maximum load on the spring portion, the first portion and the second portion can run parallel to one another and/or perpendicular to the actuation axis.

In aspects of the present disclosure, the curved portion has a radius in a range between, and inclusive of, 0.5 mm and 5 mm; in some aspects, between and inclusive of, 1 mm and 4 mm, and in some aspects, between and inclusive of, 2 mm and 3 mm.

In aspects of the present disclosure, the support portion of the clamping element is supported on a mounting piece formed separately from the valve body during operation. The mounting piece can be screwed into the valve body. The clamping element can thus be inserted into the valve body and fixed to the mounting piece. An internal thread is arranged on the valve body and an external thread on the mounting piece, or vice versa. The clamping element can thus be easily mounted in the process valve. The mounting piece can be rotationally symmetrical and/or hollow and/or arranged coaxially to the actuation axis. The mounting piece can be designed as a mounting bushing. Alternatively, the mounting piece and the valve body can be connected to one another using screws.

In aspects of the present disclosure, the clamping element is pretensioned toward the fastening portion by the mounting piece during operation. A repositioning of the shut-off body, in particular in the fastening portion, is thus further counteracted over the course of operation.

In aspects of the present disclosure, the shut-off portion of the shut-off body can be displaced between the open position and the closed position by a drive. The fastening portion of the shut-off body is fixed by the clamping element. The drive has a drive housing, wherein during operation the support portion of the clamping element is additionally or alternatively supported on the drive housing. In aspects of the present disclosure, the support portion can be arranged perpendicular to the actuation axis between the drive housing and the mounting piece. The clamping element is thus securely held radially to the actuation axis in a support receptacle.

In aspects of the present disclosure, a support ring is arranged between the mounting piece and the clamping element and/or between the drive housing and the clamping element. The clamping element is thus supported indirectly on the mounting piece and/or on the drive housing. This results in a preferential distribution of force. The support ring is rotationally symmetrical and/or hollow and/or coaxial to the actuation axis. Alternatively, the spring portion can also be designed as a finger, wherein the spring rate is adjustable. In aspects of the present disclosure, the support ring is arranged perpendicular to the actuation axis between the drive housing and the mounting piece, in particular in a support receptacle. The support ring is thus securely held radially to the actuation axis.

In aspects of the present disclosure, a clamping element for a process valve, in particular for a previously described process valve, having a support portion for at least indirect support on a valve body of the process valve, having a clamping portion for contacting a fastening portion of a shut-off body and having a spring portion for fluid-tight tensioning of the fastening portion is provided. The spring portion has a curved wall in a section coinciding with the actuation axis, wherein the wall projects at least in portions into an interior of the clamping element. The wall is arranged between the support portion and the clamping portion.

Due to the spring portion being integrated into the clamping element, fewer individual parts are required for the process valve. The process valve can therefore be assembled more easily, inexpensively and quickly. Also, the potential for errors during assembly is reduced, because fewer parts are assembled. The quality and reliability of the process valve is thus improved.

In aspects of the present disclosure, the wall has a curved inner side adjoining the interior of the clamping element and a curved outer side adjoining a recess of the clamping element. The clamping element is rotationally symmetrical and/or hollow. The clamping element has a pressure portion adjoining the spring portion and encompassing the clamping portion.

In aspects of the present disclosure, the spring portion has a first portion adjoining the pressure portion and/or tapering along the actuation axis, a second portion faces away from the pressure portion and/or widens along the actuation axis, and a curved portion connects the first portion and the second portion.

In aspects of the present disclosure, the curved portion is convex radially outward with respect to the actuation axis and/or wherein, during operation, the first portion and/or the second portion are arranged parallel or obliquely to the actuation axis, in particular the first portion and/or the second portion enclose an angle with the actuation axis in a range between and inclusive of 150° and 175°; in some aspects between and inclusive of 160° and 170°. Due to the elastic design of the spring portion, the angles between the first portion or second portion and the actuation axis change depending on the preloading force and/or valve position.

In aspects of the present disclosure, the first and/or second portion are arranged parallel to the actuation axis.

In aspects of the present disclosure, the curved portion has a radius in a range between and inclusive of 0.5 mm and 5 mm; in some aspects, between and inclusive of 1 mm and 4 mm; and in some aspects, between and inclusive of v2 mm and 3 mm.

In aspects of the present disclosure, a method for producing a clamping element as described above, wherein the clamping element is produced in a primary forming process and/or forming process and/or separating manufacturing process is provided. The clamping element is produced using an injection molding process.

Further advantages, features, and details emerge from the following description, in which various exemplary embodiments of the present disclosure are illustrated with reference to the drawings. The features mentioned in the claims and in the description may in each case be essential to the present disclosure individually or in any desired combination.

### BRIEF DESCRIPTION OF THE DRAWINGS

Further advantages and aspects of this disclosure emerge from the claims and from the following description of preferred exemplary embodiments of this disclosure, which are explained below with reference to the figures. Identical and functionally corresponding elements are provided with identical reference signs. In the drawings:

FIG. 1 is a side sectional view of a prior art process valve with disk springs;

FIG. 2 is a side sectional view of a process valve according to the present disclosure having a clamping element according to the present disclosure;

FIG. 3 is a side view of a clamping element according to FIG. 2 in a non-tensioned state;

FIG. 4 is a side view of a clamping element according to FIG. 2 in a tensioned state; and

FIG. 5 is a side sectional view of a clamping element according to FIG. 2 in a tensioned state.

### DETAILED DESCRIPTION

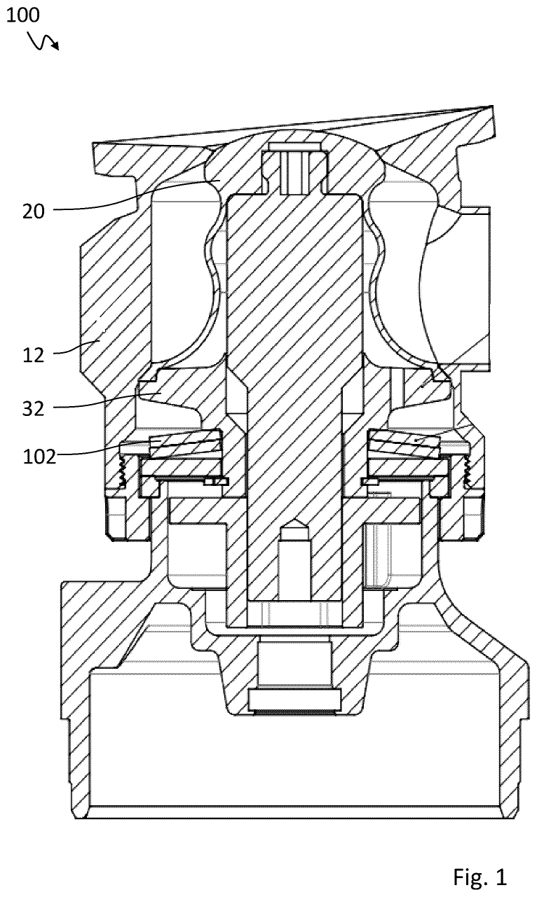

According to FIG. 1, some process valves such as process valve 100 has a valve body 12 and a shut-off body 20, wherein the shut-off body 20 is held in the valve body 12 by a clamping element 32. The clamping element 32 is pushed against the shut-off body 20 and the valve body 12 by a package of disk springs 102. The assembly of disk springs 102 requires the handling of several components, wherein the integration of the spring portion 42 into the clamping element 32 means that only a one-piece clamping element 32 needs to be assembled.

The technical problem addressed by the present disclosure is the provision of a process valve that ensures reliable and durable sealing of a shut-off body within the valve body over time, while reducing the number of components and simplifying assembly. Conventional solutions typically rely on separate disk springs or multi-part preloading assemblies, which increase part count, installation complexity, and the potential for performance degradation due to settling of the shut-off body. The present disclosure solves this problem by integrating a spring portion directly into the clamping element, thereby providing a preloading force that maintains the shut-off body's position and sealing function, even after operational settling. This one-piece structure reduces the potential for assembly error, lowers manufacturing costs, and allows for compact valve designs with consistent preload characteristics.

Unless otherwise indicated, all terms used in this disclosure are intended to have their ordinary and customary meaning as understood by a person of ordinary skill in the art. The following definitions are provided to clarify the meaning of certain terms as used herein and are not intended to limit the scope of the disclosure or the appended claims. In the event of a conflict between a definition provided herein and the ordinary meaning of a term, the definition provided herein shall control.

As used herein, actuation axis refers to the central linear axis along which the shut-off portion of the valve is displaced between open and closed positions.

As used herein, spring portion refers to a resiliently deformable region of the clamping element that provides a preloading force to maintain contact between the clamping portion and the fastening portion of the shut-off body.

As used herein, clamping portion refers to a portion of the clamping element configured to contact and exert a sealing force on the fastening portion of the shut-off body.

As used herein, preloading force refers to a biasing force generated by the spring portion prior to or during operation, which compensates for settling or dimensional variations over time.

As used herein, fluid-tight refers to a sealing condition that prevents process fluid from leaking past the fastening portion under normal operating conditions.

As used herein, support portion refers to a region of the clamping element that is configured to bear mechanical load through direct or indirect engagement with the valve body, a mounting piece, or a drive housing.

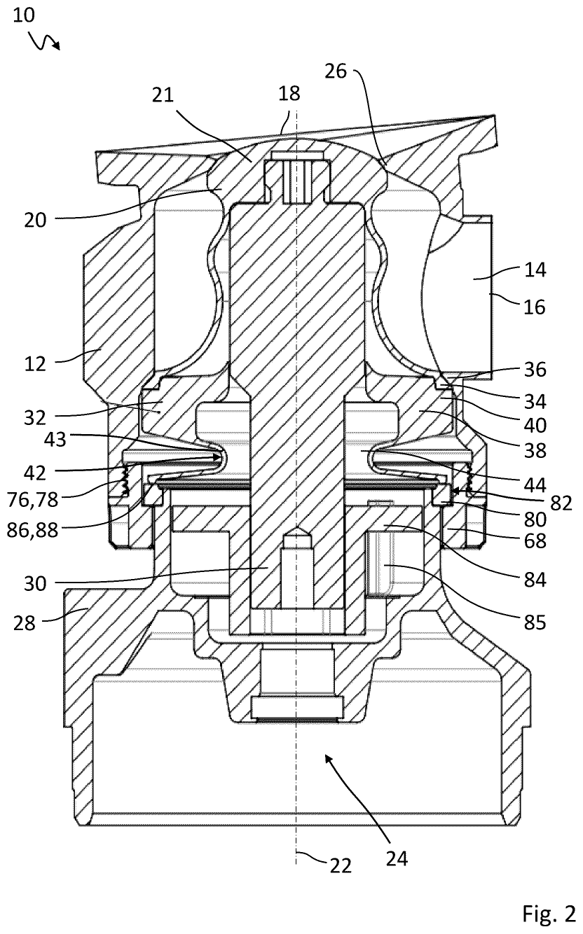

According to FIG. 2, the process valve 10 according to the present disclosure has a valve body 12 with a through-line 14, wherein the through-line 14 extends between an inlet 16 and an outlet 18. During operation, a rotationally symmetrical shut-off body 20 with a shut-off portion 21 and a fastening portion 34 is arranged in the valve body 12, wherein the shut-off portion 21 can be displaced along an actuation axis 22 between an open position for opening the through-line 14 and a closed position for closing the through-line 14 by a drive 24. In the open position, the inlet 16 and the outlet 18 are fluidly connected to one another. In the closed position, the inlet 16 and the outlet 18 are fluidically separated from one another. The shut-off body 20 is configured as a plug shut-off body 20. In the closed position, the shut-off body 20 rests on a rotationally symmetrical mounting seat 26 of the valve body 12.

The drive 24 is arranged in a drive housing 28, wherein the drive housing 28 is fastened, (e.g., screwed) to the valve body 12. A drive rod 30 of the drive 24 is connected on the one hand to a drive device (not shown) and on the other hand is connected (e.g., screwed) to the shut-off body 20 for displacing the shut-off portion 21. During operation, the drive rod 30 extends partially from the drive housing 28 into the valve body 12.

A rotationally symmetrical clamping element 32 is provided for fastening the shut-off body 20 in the valve body 12. The clamping element 32 holds or clamps a fastening portion 34 of the shut-off body 20 against a mounting seat 36 of the valve body 12, so that the shut-off body 20 is fastened in the valve body 12.

For this purpose, the clamping element 32 has a pressure portion 38 facing the shut-off body 20 with a clamping portion 40 and a spring portion 42 facing away from the shut-off body 20 for the spring-loaded tensioning of the clamping element 32, in particular the clamping portion 40, against the fastening portion 34 of the shut-off body 20. The spring portion 42 serves to ensure that the shut-off body 20 is securely held or clamped in the valve body 12 even if the shut-off body 20 settles over time during operation. Due to the spring portion 42 being integrated into the clamping element 32, easier assembly and a smaller installation height of the process valve 10 can be achieved. The spring portion 42 has a curved wall 43.

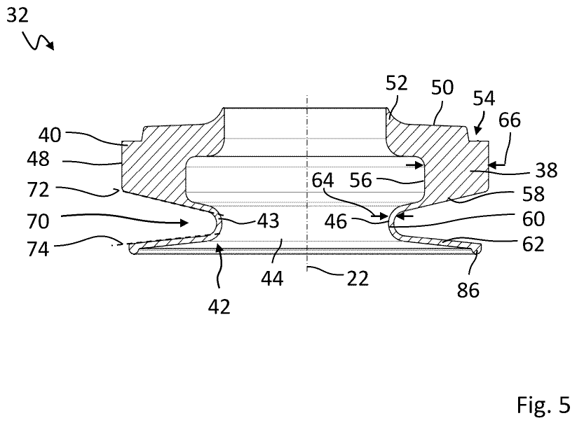

The clamping element 32 is hollow according to FIG. 5 and has an interior 44 on the inside. The clamping element 32 further has an inner side 46 facing the actuation axis 22 and adjoining the interior 44 and an outer side 48 facing away from the actuation axis 22. The interior 44 is designed such that the drive rod 30 extends through the interior 44 of the clamping element 32 and into the valve body 12. To guide the drive 24, the pressure portion 38 has a guide lip 52 adjoining the drive rod 30 on a clamping side 50 of the clamping element 32 facing the shut-off body 20. The clamping element 32 further has a ring receptacle 54 for at least partially receiving the shut-off body 20, in particular the fastening portion 34, wherein the ring receptacle 54 adjoins the clamping side 50 and/or outer side 48 of the clamping element 32. The fastening portion 34 is thus held or clamped parallel and/or perpendicular to the actuation axis 22 between the mounting seat 36 and the clamping element 32.

The clamping element 32 has also an inner shoulder 56 in the interior 44, which has a larger inner diameter than the guide lip 52. In the region of the inner shoulder 56, the drive rod 30 is arranged perpendicular to the actuation axis 22 and at a distance from the clamping element 32. The spring portion 42 adjoins the inner shoulder 56 along the actuation axis 22.

The spring portion 42 has a first portion 58, a curved portion 60 and a second 62. The first portion 58 adjoins the pressure portion 38 and/or the inner shoulder 56. The curved element 60 is arranged between the first portion 58 and the second portion 62.

The first portion 58 is formed flush with the pressure portion 38 on the outer side 48 and/or merges into the pressure portion 38 on the outer side 48. The first portion 58 merges into the inner shoulder 56 on the inner side 46. The first portion 58 tapers along the actuation axis 22. The outer side 48 of the first portion 58 and/or the adjoining region of the pressure portion 38 are conical. When in the unassembled state and/or during operation, the first portion 58, in particular the outer side 48 on the first portion 58, encloses an angle with the actuation axis 22 which lies in a range between and inclusive of 150° and 175°; and in some aspects, between and inclusive of 160° and 170°.

The curved portion 60 connects the first portion 58 and the second portion 62. The curved portion 60 has an inner diameter which is equal to or smaller than the inner diameter of the guide lip 52. The curved portion 60 has a radius of curvature which lies in a range between and inclusive of 0.5 mm and 5 mm; in some aspects, between and inclusive of 1 mm and 4 mm; and in some aspects, between and inclusive of 2 mm and 3 mm. Accordingly, both the inner side 46 and the outer side 48 in the curved portion 60 are designed to be curved.

The second portion 62 serves to transmit the clamping force at least indirectly from the valve body 12 via the spring portion 42 and the pressure portion 38 to the fastening portion 34 of the shut-off body 20. The second portion 62 widens along the actuation axis 22. The outer side 48 of the second portion 62 is conical. When in the unassembled state and/or during operation, the second portion 62, in particular the outer side 48 on the second portion 62, encloses an angle with the actuation axis 22 which lies in a range between and inclusive of 150° and 175°; and in some aspects between and inclusive of 160° and 170°.

The outer side 48 has a larger outer diameter in the pressure portion 38 than in the second portion 62.

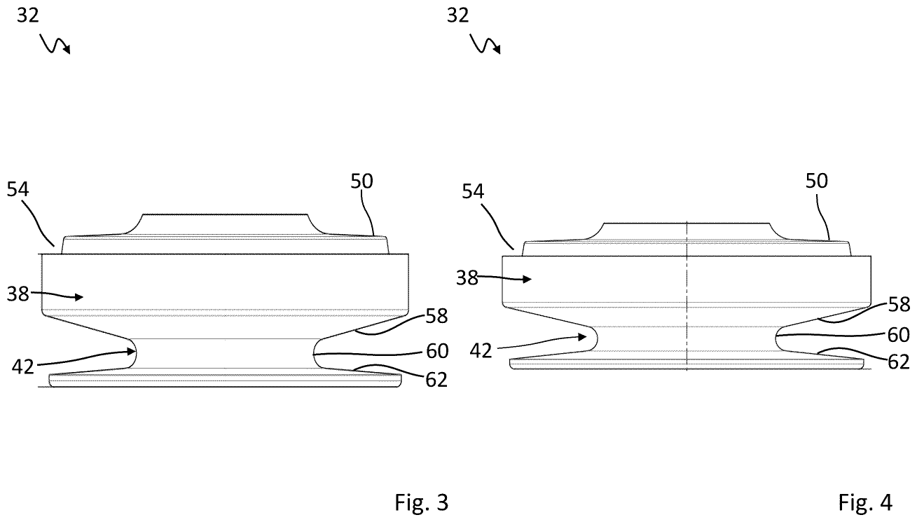

In the loaded and/or pretensioned state, the first portion 58 and the second portion 62 are displaced toward one another, wherein the curved portion 60 serves as a kind of hinge. According to FIGS. 3 and 4, the angles which the first portion 58 and/or the second portion 62 enclose with the actuation axis 22 are reduced in magnitude.

The spring portion 42, in particular the wall 43, is thin-walled. The pressure portion 38 is thick-walled. Accordingly, a first wall thickness 64 of the spring portion 42, in particular of the wall 43, is smaller than a second wall thickness 66 of the pressure portion 38. The first wall thickness 64 is uniform over the curved portion 60 and/or the first portion 58 and/or the second portion 62.

The inner side 46 of the spring portion 42, in particular of the wall 43, directly adjoins the interior 44 of the clamping element 32 on the inside. The outer side 48 of the spring portion 42, in particular of the wall 43, directly adjoins a recess 70 of the clamping element 32 on the outside. The spring portion 42, in particular the wall 43, is curved, wherein the curved portion 60 forms an arc with a radius of curvature. The outer side 48 of the first portion 58 extends along a conical first plane 72. The outer side 48 of the second portion 62 extends along a conical second plane 74.

To assemble the process valve 10, the shut-off body 20 is inserted into the valve body 12 according to FIG. 2, so that the shut-off body 20 with the fastening portion 34 rests against the mounting seat 36. The clamping element 32 is then inserted into the valve body 12, wherein the fastening portion 34 engages in the ring receptacle 54 of the clamping element 32. A rotationally symmetrical and/or hollow mounting piece 68, in particular in the form of a mounting bushing, is then fastened to the valve body 12, wherein the mounting piece 68 is screwed with an external thread 76 to an internal thread 78 of the valve body 12. Furthermore, the drive housing 28 is fastened to the valve body 12. In aspects of the present disclosure, the drive housing 28 is fixed to the valve body 12 by the mounting piece 68.

The mounting piece 68 and/or the drive housing 28 contact the clamping element 32 directly at a support portion 86 or indirectly via a rotationally symmetrical support ring 80. In one case, the mounting piece 68 and/or the drive housing 28 rests directly against the clamping element 32. In the other case, the force is transmitted from the mounting piece 68 and/or the drive housing 28 to the clamping element 32 by the support ring 80. The mounting piece 68 and the drive housing 28 form a cup-shaped support recess 82 with which the clamping element 32 and/or the support ring 80 engages. In such case, the clamping element 32 and/or the support ring 80 is held securely not only parallel, but also perpendicular, to the actuation axis 22. The mounting piece 68 and/or the drive housing 28 are mounted on the valve body 12 in such a way that the clamping element 32 is pretensioned in the direction of the shut-off body 20. In the pretensioned state, the support portion 62 and the intermediate portion 58 are displaced toward one another.

According to FIG. 5, a bead can be arranged in an annular shape on the support portion 86, which in the assembled state engages with an end groove 88 of the support ring 80 and/or of the support recess 82, so that the clamping element 32 can be mounted more easily and fixed perpendicular to the actuation axis 22.

According to FIG. 2, a drive collar 84 can be arranged on the drive rod 30, which surrounds the drive rod 30. The drive collar 84 is T-shaped in cross-section. The drive collar 84 rests against an inner side 46 of the drive housing 28. In aspects of the present disclosure, the drive collar 84 is arranged such as to be movable in a guide groove 85, so that the drive 24, in particular the drive rod 30, is secured against rotation. To limit the movement of the drive 24, in particular of the drive rod 30, the spring portion 42 is configured such that the drive collar 84 comes to rest against the spring portion 42 in a maximum deflection position in which the valve is closed. In such case, the drive collar 84 serves as a stop.

In aspects of the present disclosure, the clamping element 32 is first produced in a primary forming process and/or in a forming process and in particular then inserted into the valve body 12. During the production process, the properties of the clamping element 32, in particular the spring characteristic of the spring portion 42, can be adjusted as desired in order to ensure secure tensioning of the shut-off body 20.

The shut-off body 20 can be designed to be in one piece and rotationally symmetrical to the actuation axis 22. The shut-off body 20 is fixed to the valve body 12 by a lateral fastening portion 34 which is triangular in longitudinal section. In particular, the fastening portion 34 is clamped. A shut-off portion 21 interacts with a valve seat 26 to limit a flow of a process fluid through the process valve 10. According to FIG. 2, a thin membrane wall connects the fastening portion 34 to the shut-off portion 21, which is movable along the actuation axis 22. If the shut-off body 20 is arranged within the valve body 12 and fixed to the valve body 12 by the lateral fastening portion 34, the shut-off body 20 separates a media side from a dry side.

A first wall profile 200 curves toward the dry side and thus defines a media-side cavity. The first wall profile 200 follows, at least in portions, an imaginary torus, which is generated by rotating a circle with a media-side center point and a radius about the actuation axis 22. A second wall profile 202 curves toward the media side and thus defines a dry-side cavity. The second wall profile 202 follows, at least in portions, an imaginary torus, which is generated by rotating a circle with a dry-side center and a radius about the longitudinal axis 22. A third wall profile 204 curves toward the dry side and thus defines a media-side cavity. The third wall profile follows, at least in portions, an imaginary torus, which is generated by rotating a circle with a media-side center point and a radius about the actuation axis 22. The third wall profile 204 merges into the solidly designed shut-off portion 21, which can also be referred to as a closing body, wherein a tangent (not shown) of the third wall profile 204 runs parallel to the actuation axis 22 at an associated transition point. A fourth wall profile 206 adjoins the lateral fastening portion 34 and follows an imaginary flat cone. The fourth wall profile 206 thus tapers in the direction of the first wall profile 200 in a flat conical shape. Of course, other embodiments of the wall profile 206 are provided in other aspects of the present disclosure. For example, the wall profile 206 can also have a curvature in the direction of the dry side. A media-side surface of the wall profile 206 thus provides a discharge geometry for the process fluid. The discharge geometry for the process fluid connects inward to the lateral fastening portion 34. The discharge geometry for the process fluid connects outward to the first wall profile 200. The discharge geometry is thus located between the fastening portion 34 and the first wall profile 200.

The process valve and clamping element disclosed herein offer several advantages over conventional designs. By integrating the spring portion directly into the clamping element as a curved wall structure, the number of separate components is reduced, resulting in simplified assembly, lower manufacturing costs, and reduced risk of assembly errors. The integrated spring portion provides a consistent preloading force that compensates for settling of the shut-off body over time, thereby maintaining reliable sealing performance throughout the service life of the valve. Additionally, the compact geometry of the clamping element enables a reduced installation height, making the valve suitable for space-constrained applications. The geometric features of the spring portion, including its conical and curved segments, allow the spring characteristics to be precisely tailored for a given application, improving operational reliability and durability. These benefits collectively enhance the overall quality, robustness, and cost-efficiency of the process valve.

### LIST OF REFERENCE SIGNS

10 Process valve
12 Valve body
14 Through-line
16 Inlet
18 Outlet
20 shut-off body
21 Shut-off portion
22 Actuation axis
24 Drive
26 Valve seat
28 Drive housing
30 Drive rod
32 Clamping element
34 Fastening portion
36 Mounting seat
38 Pressure portion
40 Clamping portion
42 Spring portion
43 Wall
44 Interior
46 Inner side
48 Outer side
50 Clamping side
52 Guide lip
54 Ring receptacle
56 Inner shoulder
58 First portion
60 Curved portion
62 Second portion
64 First wall thickness
66 Second wall thickness
68 Mounting piece
70 Recess
72 First plane
74 Second plane
76 External thread
78 Internal thread
80 Support ring
82 Support recess
84 Drive collar
85 Guide groove
86 Support portion
88 End groove
100 Known process valve
102 Disk springs

To the extent not already described, the different features and structures of the various embodiments can be used in combination, or in substitution with each other as desired. That one feature is not illustrated in all of the embodiments is not meant to be construed that it cannot be so illustrated, but is done for brevity of description. Thus, the various features of the different embodiments can be mixed and matched as desired to form new embodiments, whether or not the new embodiments are expressly described. All combinations or permutations of features described herein are covered by this disclosure.

Persons skilled in the art will understand that the structures and methods specifically described herein and shown in the accompanying figures are non-limiting exemplary aspects, and that the description, disclosure, and figures should be construed merely as exemplary of aspects. It is to be understood, therefore, that the present disclosure is not limited to the precise aspects described, and that various other changes and modifications can be effected by one skilled in the art without departing from the scope or spirit of the disclosure.

Additionally, the elements and features shown or described in connection with certain aspects can be combined with the elements and features of certain other aspects without departing from the scope of the present disclosure, and that such modifications and variations are also included within the scope of the present disclosure. Accordingly, the subject matter of the present disclosure is not limited by what has been particularly shown and described.

What is claimed:

1. A process valve comprising:
a valve body having at least one through-line;
a shut-off body including a fastening portion and a shut-off portion, wherein the shut-off portion is movable along an actuation axis to selectively close the through-line;
a clamping element; and
a drive rod connected to the shut-off portion and extending through an interior of the clamping element;
wherein the clamping element includes:
a clamping portion configured to tension the fastening portion of the shut-off body in a fluid-tight manner against the valve body;
a support portion configured to provide at least indirect support for the clamping element on the valve body; and
a spring portion configured to generate a preloading force that counteracts a force acting on the support portion of the clamping element through the fastening portion of the shut-off body;
wherein the spring portion includes a curved wall that projects at least partially into the interior of the clamping element and is arranged between the support portion and the clamping portion.

2. The process valve of claim 1, wherein the curved wall has a curved inner side adjoining the interior of the clamping element and a curved outer side adjoining a recess of the clamping element.

3. The process valve of claim 1, wherein, during operation, the clamping portion is arranged between the spring portion and the fastening portion of the shut-off body.

4. The process valve of claim 1, wherein the spring portion has a first wall thickness and the clamping portion has a second wall thickness, and wherein the first wall thickness is less than the second wall thickness.

5. The process valve of claim 1, wherein the spring portion includes a first portion that faces the shut-off body and tapers along the actuation axis, a second portion that faces away from the shut-off body and widens along the actuation axis, and a curved portion connecting the first portion and the second portion.

6. The process valve of claim 5, wherein the first wall thickness of the spring portion is substantially uniform in the first portion, the curved portion, and the second portion.

7. The process valve of claim 5, wherein the curved portion is convex in a radially outward direction with respect to the actuation axis.

8. The process valve of claim 1, wherein, in an unassembled state or during operation, the first portion and the second portion of the spring portion are arranged parallel or obliquely to the actuation axis, and wherein the first portion and the second portion each form an angle with the actuation axis in a range from 150 degrees to 175 degrees.

9. The process valve of claim 1, wherein the support portion of the clamping element is supported on a mounting piece that is formed separately from the valve body.

10. The process valve of claim 9, wherein the clamping element is pretensioned toward the fastening portion of the shut-off body by the mounting piece during operation.

11. The process valve of claim 1, further comprising a drive configured to displace the shut-off portion between an open position and a closed position along the actuation axis, wherein the drive includes a drive housing, and wherein the support portion of the clamping element is supported on the drive housing during operation.

12. The process valve of claim 11, further comprising a support ring arranged between the mounting piece and the clamping element or between the drive housing and the clamping element.

13. A clamping element for a process valve, the clamping element comprising:
a support portion configured to provide at least indirect support on a valve body;
a clamping portion configured to contact a fastening portion of a shut-off body; and
a spring portion configured to tension the fastening portion in a fluid-tight manner;
wherein the spring portion includes a curved wall that projects at least partially into an interior of the clamping element, and wherein the curved wall is arranged between the support portion and the clamping portion.

14. The clamping element of claim 13, wherein the curved wall has a curved inner side adjoining the interior and a curved outer side adjoining a recess of the clamping element.

15. The clamping element of claim 13, wherein the spring portion includes a first portion that adjoins the clamping portion and tapers along the actuation axis, a second portion that faces away from the clamping portion and widens along the actuation axis, and a curved portion connecting the first portion and the second portion.

16. The clamping element of claim 15, wherein the curved portion is concave in a radially outward direction with respect to the actuation axis, and wherein the first portion and the second portion are arranged parallel or obliquely to the actuation axis and form an angle with the actuation axis in a range from 150 degrees to 175 degrees.

17. A method of producing a clamping element for a process valve, the method comprising:
forming the clamping element in a primary forming process, a forming process, a separating process, or a machining process.
